(19) United States
(12) Patent Application Publication
(10) Pub. No.: US 2023/0308844 A1
(43) Pub. Date: Sep. 28, 2023

(54) METHOD AND DEVICES FOR IDENTIFYING AN OBJECT AS THE SOURCE OF A V2X SIGNAL

(71) Applicant: Robert Bosch GmbH, Stuttgart (DE)

(72) Inventors: Lutz Bersiner, Hildesheim (DE); Philip Wette, Bueckeburg (DE)

(21) Appl. No.: 18/041,700

(22) PCT Filed: Sep. 24, 2021
(86) PCT No.: PCT/EP2021/076341

§ 371 Date: Feb. 15, 2023

(30) Foreign Application Priority Data
Sep. 28, 2020 (DE) 10 2020 212 174.5

(51) Int. Cl. H04W 4/46; G01S 5/02; G01S 13/88; G01S 17/88

(52) U.S. Cl. CPC H04W 4/46; G01S 5/0284; G01S 13/88; G01S 17/88

(57) ABSTRACT

A method for identifying an object as the source of a V2X signal. The method includes: receiving a V2X signal from a source by a receiver of a first vehicle; performing a relative position estimation using an environment sensor system of the first vehicle, an object from the surroundings of the first vehicle being detected, and a relative position between the first vehicle and the object being determined, the environment sensor system receiving environment signals of the object, and the object modulating the environment signals at least with a part of a V2X signal of the object; receiving the modulated environment signals by the environment sensor system of the first vehicle, and demodulating the received environment signals by the first vehicle, and ascertaining a V2X identifier of the object; comparing the V2X identifier of the object with the V2X signal of the source.

### FIELD

The present invention relates to a method for identifying an object as the source of a V2X signal. The present invention further relates to a device for identifying an object as the source of a V2X signal, and to a vehicle having such a device. The present invention further relates to a device that is configured to be identified as the source of a V2X signal, and to a vehicle having such a device.

### BACKGROUND INFORMATION

Systems in which vehicles are able to exchange communication information wirelessly, in particular via radio, with each other or with infrastructure installations, have already been proposed in the related art. A data exchange of this type between vehicles, or between vehicles and infrastructure, is known as vehicle-to-vehicle communication (V2V communication) in the specific case of communication between vehicles, or as vehicle-to-X communication (V2X communication) in the general case.

Standards have already been set both for the communication information exchanged and for the radio communication, these standards are available in principle from the related art.

It is conventional, for example, to broadcast the GPS position and/or the speed of a vehicle as communication information items to other vehicles in the surroundings that are configured for V2V (vehicle-to-vehicle) communication. Vehicle systems that receive the communication information of other vehicles via the radio channel, and also know their own GPS position, are able to calculate the relative distances between their own, receiving, vehicle and the surrounding, transmitting, road users in a plane coordinate system using transformations, e.g., a UTM transformation. V2V communication can therefore be modeled as a “sensor” in a figurative sense, which detects objects in its surroundings, similarly to actual environment sensors of a vehicle, e.g., radar sensors, cameras, laser sensors and the like, and measures their relative distances and speeds.

Furthermore, some convention vehicle systems from the related art associate the communication information and/or communication objects which are received via the vehicle-to-vehicle communication with environment data provided by an environment sensor. In this case, for example, environment models are used in which the relative position of other objects is recorded, it being possible for further information items to be allocated to each of these objects, for example the relative speed and/or other properties of the object. Environment models of this kind may be enhanced with further information about other vehicles by utilizing the communication information.

In order to make this kind of allocation possible, it is first necessary to find out to which object detected by the environment sensors and described by the environment data a transmitter (transmitting apparatus) that has provided the communication information belongs. For this purpose, it is conventional in the related art, as described above, to ascertain a relative position and speed of the vehicle comprising the transmitter from a GPS position and a transmitted speed as a vehicle-to-vehicle communication object. Relative positions and speeds of environment sensor objects detected by the environment sensors are then also known in the environment data. These relative positions and speeds can then be compared.

If the environment sensor object to which the transmitter is to be allocated is identified, remote vehicle information contained in the communication information can accordingly be allocated to this environment sensor object.

An essential aspect of a successful correlation of data originating from the same object (e.g. vehicle) but from different information sources, namely from the vehicle-to-vehicle information and the environment sensors, is a comparison of the relative positions. While an environment sensor is able to measure such relative positions very accurately, the calculation of the relative positions via V2V communication is based on GPS coordinates, which can only be determined with insufficient accuracy by the conventional methods at present. This can lead to the case that the data received from another vehicle via V2V communication and the data ascertained from a corresponding object by the environment sensor do not appear to belong together. If more than two V2V partners are involved, it may also be the case that the receiving vehicle allocates the V2V data to the wrong sensor object.

German Patent Application No. DE 10 2012 020 297 A1 describes a method for allocating a transmitter which transmits at least one item of communication information in vehicle-to-vehicle communication to an object being described by environment data from at least one environment sensor in a receiving motor vehicle, wherein the allocation occurs based on comparing environment data from at least one environment sensor of the motor vehicle comprising the transmitter, which are contained in the communication information, with corresponding environment data of the receiving motor vehicle. Here too, it may be the case that the data received from another vehicle via V2V communication and the data ascertained by the environment sensor from a corresponding object do not appear to belong together, or, if more than two V2V partners are involved, that the receiving vehicle allocates the V2V data to the wrong sensor object.

### SUMMARY

An object of the present invention is to provide a way in which a V2X message transmitted by an object may be allocated to this object in an error-free fashion. Other objects that emit radio messages should be differentiated, as well as those that do not transmit any V2X messages.

The object may be achieved by the features of the present invention. Advantageous embodiments of the present invention are disclosed herein.

According to the present invention, a method for identifying an object as the source of a V2X signal is provided. According to an example embodiment of the present invention, the method includes the following steps:
receiving a V2X signal from a source by a receiver of a first vehicle;
performing a relative position estimation, by way of an environment sensor system of the first vehicle, with an object from the surroundings of the first vehicle being detected by way of the environment sensor system, and with a relative position between the first vehicle and the object, in particular a second vehicle, being determined by way of the environment sensor system, the environment sensor system receiving environment signals from the object, and the object modulating the environment signals at least with a part of a V2X signal of the object;
receiving the modulated environment signals by the environment sensor system of the first vehicle, and demodulating the received environment signals by a signal-processing unit of the first vehicle, and thus ascertaining a V2X identifier of the object;
comparing the V2X identifier of the object with the V2X signal of the source, the object being identified as the 10 source of the V2X signal if the V2X identifier of the object and the V2X signal of the source have a sufficient correlation.

V2X here denotes the communication of a vehicle (V for vehicle) with a further road user, e.g., a further vehicle or an RSU (roadside unit). Further communication partners are possible, and are available in the related art. In particular, V2X also includes communication between two vehicles (also known as V2V).

A sufficient correlation may be understood to mean that the V2X identifier of the object and the V2X signal of the source at least partially match. For example, a correlation value of the signals may be calculated, the object being identified as the source of the V2X signal if the correlation value exceeds a specific, predefined limit value.

The steps of receiving a V2X signal and of performing a relative position estimation may be carried out consecutively, the order being unimportant. These steps may also be carried out simultaneously.

The present invention is thus based on a modulation (i.e. change) of that signal which is detected by an environment sensor system in a way that correlates with a V2X message transmitted in the same time period. The present invention is applicable to different sensors, such as radar, lidar, or camera systems with appropriate image recognition. The present invention advantageously allows objects to be clearly allocated to the V2X messages sent thereby. A further advantage is that it is independent of any type of localization technology, insofar as neither transmitter nor receiver needs a priori knowledge of its own position, or of that of the partner. The method according to the present invention is suitable, for example, for cooperative localization methods, in which the partners involved do not initially know their position, or know it only imprecisely.

The present invention is suitable for implementation in vehicles for allocating V2V messages of other vehicles, but also for implementation in stationary installations (roadside units RSUs) for allocating V2X messages in both directions.

In one preferred variant of the present invention, the V2X signal of the source comprises a clear V2X identifier of the source. To preserve the privacy of vehicle drivers, road users may employ (temporarily) changing pseudonyms (known as station IDs) in V2X communication. These will be referred to below as V2X identifiers. The V2X identifier of a participant is sent with every transmitting operation in order for the sender to be able to be clearly identified. Furthermore, in this variant, an environment signal of the object is modulated with a clear V2X identifier of the object. Consequently, the clear V2X identifier of the object is determined when the environment signal is demodulated. By comparing the V2X identifier of the object with the V2X identifier of the source of the V2X signal, the object can be identified as the source of the V2X signal if the V2X identifiers have a sufficient correlation to one another, and in particular if they match.

In one preferred variant of the present invention, the relative position estimation is performed based on a time-of-flight measurement, the environment sensor system of the first vehicle emitting a measuring signal, in particular an electromagnetic wave, at a first point in time, and the environment signal of the object being transmitted in response to the arrival of the measuring signal. The environment sensor system of the first vehicle receives the environment signal at a second point in time, a distance between the first vehicle and the object, e.g. a second vehicle, being calculated based on the time difference between the first point in time and the second point in time. In other words, the relative position estimation in this variant is based on emitting a measuring signal and receiving a measuring signal, generally assumed to be reflected by an object, as an environment signal. In this case, a time difference between emitting and receiving can be determined in a conventional manner, and, with a known propagation velocity of the signal, a distance or separation between the transmitter and the reflecting object can be calculated therefrom. A wide variety of examples of environment sensor systems that operate according to this principle are available in the related art.

According to the present invention, this conventional principle is modified such that, in response to the incoming measuring signal, an environment signal is transmitted by a corresponding device of the object, e.g., an active transmitter, and is perceived by the environment sensor system of the first vehicle as a reflected signal. This transmitted signal is modulated with at least a part of a V2X signal of the object, in particular with a clear V2X identifier of the object.

In particular, according to an example embodiment of the present invention, the environment sensor system of the first vehicle comprises a radar sensor, with a radar signal being emitted as a measuring signal, by way of the radar sensor, into the surroundings of the first vehicle. The object includes at least one active radar reflector, the active radar reflector receiving the transmitted radar signal and, in response thereto, transmitting a second radar signal as an environment signal, the second radar signal being modulated with at least a part of a V2X signal of the object, in particular with a clear V2X identifier of the object.

Active radar reflectors are available in the related art, e.g. in shipping and aviation, under the designation SART (search and rescue radar transponder). These active radar reflectors are able to receive incoming radar waves, and to send them back in an amplified and modulated fashion with a slight delay, typically of a few nanoseconds. The amplified radar waves that are sent back are modulated according to the present invention with a part of the simultaneously sent V2X message, e.g., with the V2X identifier. It may be that the receiving vehicle recognizes a plurality of objects by radar, but only one that has a sufficient correlation with the simultaneously received V2X message.

Alternatively or in addition, the environment sensor system of the first vehicle may comprise a lidar sensor, with a lidar signal being emitted as a measuring signal, by way of the lidar sensor, into the surroundings of the first vehicle. The object includes at least one photosensor and a lidar signal transmitter, the photosensor receiving the transmitted lidar signal and, in response thereto, a second lidar signal being transmitted as an environment signal by the lidar signal transmitter, the second lidar signal being modulated with at least a part of a V2X signal of the object, in particular with a clear V2X identifier of the object. Similarly to the active radar reflector, the transmitting object in this case carries, for example, infrared transmitters (IRLEDs) that are visible to lidar from all directions, which transmit IR signals that are modulated with at least a part, in particular the V2X identifier, of the simultaneously sent V2X message as soon as a lidar scan of the first vehicle is registered. The latter requires a photosensor, e.g., an IR photodetector, on the part of the V2X-transmitting object. The IR photodetectors employed do not need to have high sensitivity in this case, since only the relatively strong laser scanning light of the incoming lidar signal has to be registered (and not the backscattering thereof, for instance). Furthermore, an advantage of IR photodetectors is their high detection speed.

The V2X-receiving vehicle is then able to receive, for example, the sequential V2X identifier of the transmitting object in addition to the lidar reflection. It may be that the first vehicle recognizes a plurality of objects by way of its lidar sensor, but only one that has a sufficient correlation with the simultaneously or previously received V2X message.

This variant works even if a plurality of receiving vehicles detect the transmitting object by way of lidar. Either the lidar beams hit the transmitting object simultaneously (i.e., within a time window), in which case the modulated reflection, which emanates from the infrared transmitter that is visible from all directions, is valid for all receiving vehicles. The distances may be different, but they are ascertained correctly by all the receiving vehicles because of the different times of flight. Or the lidar beams hit with a time difference greater than the time window. In this case, each receiving vehicle receives its own lidar reflection.

Alternatively, the modulation of the IRLEDs that are visible from all directions with at least a part of the V2X signal may take place continuously if the modulation takes place more slowly than the scanning rate (data repetition rate) of the lidar.

In another preferred variant of the present invention, the environment sensor system of the first vehicle may comprise a camera system, e.g., a stereo camera system or a video camera system. In this case, the object transmits an environment signal (in this case passively, since the camera system captures one or more images of the transmitting object for the relative position estimation), which comprises an optical signal, in particular one that is transmitted continuously, the optical signal being modulated with at least a part of a V2X signal of the object, in particular with a clear V2X identifier of the object.

To this end, the object may include, for example, one or more light sources, which are configured to transmit the modulated environment signal. For example, to this end, the object may include one or more illuminants specifically provided for this purpose, e.g., one or more LEDs. If the object is a vehicle, existing illuminants of the vehicle, such as headlamps, turning lights, stop lamps, and/or similar, may alternatively or additionally be utilized to transmit the optical signal.

According to an example embodiment of the present invention, the optical signal may include, for example, a spatial modulation. To this end, the illuminant comprises a row or an array of LEDs. A standardized V2X message of the CAM or DENM type always has a “station ID” with a length of 4 bytes. The station ID can thus be made readable by video cameras by a row of 32 LEDs, this being without any constraints due to frame frequency.

Alternatively, a temporal modulation of the optical signal may be provided. When a video camera that records images at, e.g., 30 Hz is used, a signal can be sampled at 15 Hz bandwidth. If an individual LED is used as the illuminant, a maximum of 30 bits/second can therefore be broadcast. If, for example, each object broadcasts its V2X identifier by LED once per second, it would be possible for a maximum of 23° objects to be clearly differentiated in this way. Thus, although it is not possible to broadcast the complete, 4-byte-long V2X station ID in one second, the remaining character set is nevertheless sufficient, given the dimensioning of the alternative being described here, to reliably differentiate the objects involved.

According to a second aspect of the present invention, a device is provided, which is configured to be identified as the source of a V2X signal by a method according to a variant of the present invention. To this end, according to an example embodiment of the present invention, the device comprises at least:
a computing unit, which is configured to generate a V2X signal, the V2X signal comprising in particular a clear V2X identifier;
a communication unit, to emit the V2X signal into the surroundings of the device;
a signal-transmitting unit, which is equipped to transmit an environment signal, said environment signal being modulated with at least a part of the V2X signal, in particular with the V2X identifier of the device.

The signal-transmitting unit is preferably equipped to transmit the environment signal in response to recognizing a measuring signal coming in from the outside, the device including a sensor for detecting the measuring signal.

To this end, in one preferred variant of the present invention, as described above, the signal-transmitting unit may comprise an active radar reflector, the active radar reflector receiving a radar signal as a measuring signal and, in response thereto, transmitting a second radar signal as an environment signal, the second radar signal being modulated with at least a part of the V2X signal, in particular with the V2X identifier of the device.

Alternatively or in addition, the signal-transmitting unit, as described above, may comprise a photosensor, in particular an IR sensor. The photosensor receives a lidar signal as a measuring signal. In response thereto, a second lidar signal is transmitted as an environment signal by a lidar signal transmitter of the device, the second lidar signal being modulated with at least a part of the V2X signal, in particular with the V2X identifier of the device.

Alternatively or in addition, the device may include a light source as the signal-transmitting unit, as described above, the light source continuously transmitting an optical signal as an environment signal, the optical signal being modulated with at least a part of the V2X signal, in particular with the V2X identifier of the device.

According to a third aspect of the present invention, a vehicle, in particular a motor vehicle, is provided, comprising a device according to the present invention, said device being configured to be identified as the source of a V2X signal by a method according to a variant of the present invention.

According to a fourth aspect of the present invention, a device is provided, which is configured to identify an object as the source of a V2X signal by a method according to the present invention. According to an example embodiment of the present invention, the device comprises at least:
a receiver, equipped for receiving V2X signals;
an environment sensor system, in particular comprising a camera system and/or a radar sensor and/or a lidar sensor, said environment sensor system being equipped to receive an environment signal from the surroundings of the device, and to perform, by way of the environment sensor system, a relative position estimation between the first vehicle and an object transmitting the environment signal;
a signal-processing unit, which is equipped to demodulate the environment signal in order thus to ascertain a V2X identifier of the object;
a computing unit equipped to compare the V2X identifier of the object with the V2X identifier of the source of the V2X signal, the object being identified as the source of a V2X signal if the V2X identifiers have a sufficient correlation.

According to a fifth aspect of the present invention, a vehicle, in particular a motor vehicle, is provided, comprising a device according to the present invention which is configured to identify an object as the source of a V2X signal by a method according to the present invention.

The vehicles according to the present invention are particularly preferably configured as vehicles guided in an at least partially automated fashion, in particular as highly automated or fully automated vehicles.

The formulation “guided in an at least partially automated fashion” comprises one or more of the following cases: assisted guidance, partially automated guidance, highly automated guidance, fully automated guidance.

Assisted guidance means that a driver of the vehicle constantly performs either the lateral or the longitudinal guidance of the vehicle. The other driving task in each case (that is, controlling the longitudinal or lateral guidance of the vehicle) is carried out automatically. This means, therefore, that during assisted guidance of the vehicle, either the lateral or the longitudinal guidance is controlled automatically.

Partially automated guidance means that, in a specific situation (e.g.: driving on a freeway, driving within a parking facility, overtaking an object, driving within a traffic lane which is defined by lane markings), and/or for a certain period of time, a longitudinal and a lateral guidance of the vehicle are controlled automatically. A driver of the vehicle does not himself have to control the longitudinal and lateral guidance of the motor vehicle manually. However, the driver must constantly monitor the automatic control of the longitudinal and lateral guidance in order to be able to intervene manually if necessary. The driver must be ready at all times to take over vehicle guidance completely.

Highly automated guidance means that, for a certain period of time in a specific situation (e.g.: driving on a freeway, driving within a parking facility, overtaking an object, driving within a traffic lane which is defined by lane markings), a longitudinal and a lateral guidance of the vehicle are controlled automatically. A driver of the vehicle does not himself have to control the longitudinal and lateral guidance of the vehicle manually. The driver does not have to constantly monitor the automatic control of the longitudinal and lateral guidance in order to be able to intervene manually if necessary.

If necessary, a takeover request is automatically issued to the driver, in particular with an adequate time reserve, to take over the control of the longitudinal and lateral guidance. The driver must therefore be potentially capable of taking over control of the longitudinal and lateral guidance. Limits of the automatic control of the lateral and longitudinal guidance are recognized automatically. In the case of highly automated guidance, it is not possible to bring about a minimal-risk state automatically in every starting situation.

Fully automated guidance means that, in a specific situation (e.g.: driving on a freeway, driving within a parking facility, overtaking an object, driving within a traffic lane which is defined by lane markings), a longitudinal guidance and a lateral guidance of the vehicle are controlled automatically. A driver of the vehicle does not himself have to control the longitudinal and lateral guidance of the vehicle manually. The driver does not have to monitor the automatic control of the longitudinal and lateral guidance in order to be able to intervene manually if necessary. Before the automatic control of the lateral and longitudinal guidance is ended, a request is automatically made to the driver, in particular with an adequate time reserve, to take over the driving task (controlling the lateral and longitudinal guidance of the motor vehicle). Should the driver fail to take over the driving task, reversion to a minimal-risk state occurs automatically. Limits of the automatic control of the lateral and longitudinal guidance are recognized automatically. In all situations, it is possible to revert automatically to a minimal-risk system state.

### BRIEF DESCRIPTION OF THE DRAWINGS

Specific embodiments of the present invention will be described in detail with reference to the figures.

FIG. 1 schematically shows a traffic situation with a plurality of vehicles and an RSU, in which a method according to one possible variant of the present invention is employed.

FIG. 2 shows a vehicle which is configured to be identified as the source of a V2X signal by a method according to one exemplary embodiment of the present invention in accordance with a first possible specific embodiment of the present invention.

FIG. 3 shows a vehicle which is configured to identify an object as the source of a V2X signal by a method according to one exemplary embodiment of the present invention in accordance with a second possible specific embodiment of the present invention.

FIG. 4 shows a flow diagram of a method according to one possible exemplary embodiment of the present invention.

### DETAILED DESCRIPTION OF EXAMPLE EMBODIMENTS

In the following description of the exemplary embodiments of the present invention, identical elements are referred to by identical reference numerals, a repeated description of these elements being omitted where applicable. The figures show the subject matter of the present invention only schematically.

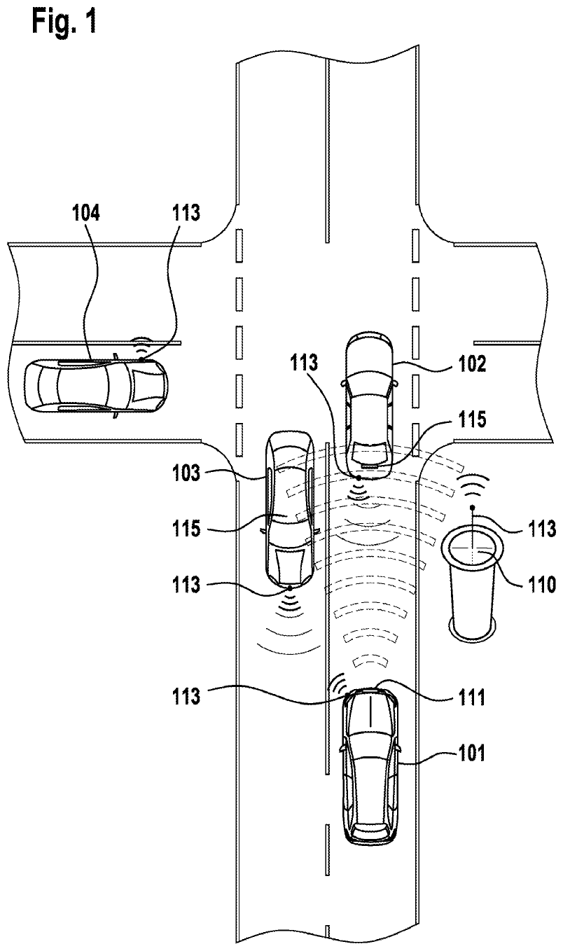

Vehicles 101, 102, 103, and 104, as well as a stationary RSU (roadside unit) 110, are involved in the traffic situation shown in FIG. 1. All the involved vehicles 101, 102, 103, and 104, as well as RSU 110, are equipped to transmit and receive messages by V2X communication. Vehicles 101, 102, 103, and 104, as well as RSU 110, include for this purpose communication apparatuses 113, which emit V2X signals into the surroundings of the respective vehicle 101, 102, 103, 104, or of RSU 110, e.g. by radio. A V2X message or V2X signal transmitted in this way comprises a clear V2X identifier of the transmitting vehicle 101, 102, 103, and 104, or of the transmitting RSU 110. This clear V2X identifier may also be referred to as a station ID, and allows the source of the V2X signal to be clearly identified. It may be provided that, to preserve anonymity, the station ID is changed at regular time intervals, but it always remains clear.

Vehicle 101 receives a V2X signal from its surroundings, and would like to identify one of the other objects in its surroundings, i.e. vehicle 102, or vehicle 103, or RSU 110, as the source of the V2X signal. To this end, a relative position estimation is performed according to the present invention by way of an environment sensor system of vehicle 101. To this end, vehicle 101 includes, for example, a radar sensor 111. By way of radar sensor 111, distances to objects in the surroundings of vehicle 101 are determined based on a time-of-flight measurement. To this end, radar sensor 111 sends out a radar signal as a measuring signal. If the radar signal is reflected back to radar sensor 111 by an object in the surroundings, the distance between vehicle 101 and the object can be calculated in a conventional manner from the time interval between the emission of the radar signal and the arrival of the reflected signal.

The V2X signal in the present example was transmitted by vehicle 102. In order for vehicle 102 to be able to be clearly identified as the source of the V2X signal, vehicle 102 includes at least one active radar reflector 115 as a signal-transmitting unit. Vehicle 102 preferably includes a plurality of active radar reflectors, which are oriented, for example, to the rear, front, right, and left of vehicle 102. When the radar signal transmitted by vehicle 101 for the relative position estimation hits the active radar reflector of vehicle 102, the radar reflector modulates the incoming signal with the station ID of vehicle 102, and transmits a radar signal that has been modulated in this way, as an environment signal, back toward vehicle 101, where it is received by way of radar sensor 111.

The environment signal that has been received in this way is demodulated by a device according to the present invention (not shown) in vehicle 101, and thus, in addition to a relative position and/or a relative distance of vehicles 101 and 102, the station ID of vehicle 102 is also ascertained. The station ID obtained by this measurement can then be compared with the station ID of the previously received V2X signal. If the two station IDs match, or exhibit at least a certain correlation, vehicle 102 can be clearly identified as the source of the V2X signal.

In the present situation, vehicle 103 is also recognized as an object by way of radar sensor 111 of vehicle 101. Vehicle 103 may also include, for example, at least one active radar reflector 115. If the radar signal transmitted by vehicle 101 for relative position estimation, and/or for determining a distance, hits the active radar reflector of vehicle 103, radar reflector 115 modulates the incoming signal with the station ID of vehicle 103, and reflects the radar signal that has been modulated in this way, as an environment signal, back to vehicle 101, where it is received by radar sensor 111. By demodulating the environment signal, the station ID of vehicle 103 can then be ascertained. Since this does not match the station ID of the received V2X signal (which, in fact, originates from vehicle 102), vehicle 103 can be ruled out as the source of the received V2X signal.

In the same way, RSU 110 can be ruled out as the source of the received V2X signal.

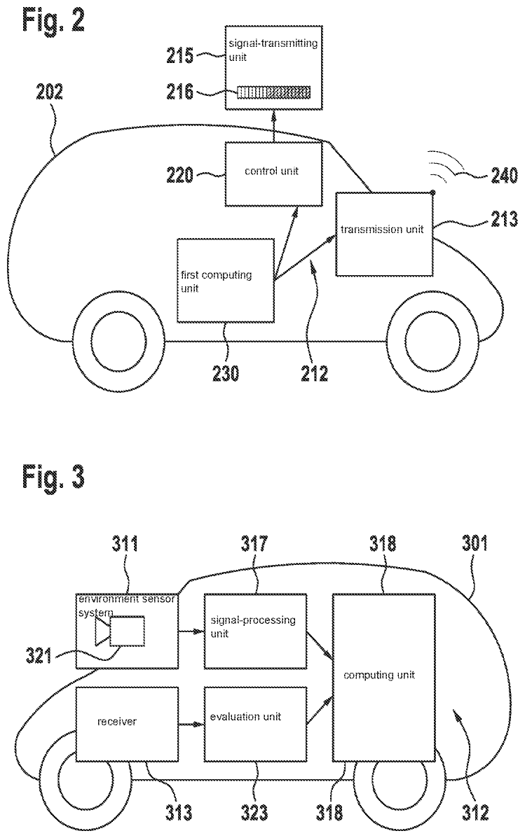

FIG. 2 shows a vehicle 202, which is configured to be identified as the source of a V2X signal by a method according to one possible exemplary embodiment of the present invention. To this end, vehicle 202 includes a device 212, which includes a first computing unit 230 for generating a V2X message. The V2X message is generated in such a way that it incorporates the current station ID of vehicle 202. The device 212 further comprises a transmission unit 213, which is configured to emit the V2X message as V2X signal 240 into the surroundings of vehicle 202. Device 212 further includes a control unit 220, which is provided with the station ID of vehicle 202.

Device 212 also comprises a signal-transmitting unit 215, which is equipped to transmit an environment signal. In the exemplary embodiment shown, the signal-transmitting unit 215 comprises a display 216 for this purpose, having a plurality of LED illuminants. The display transmits an optical signal as an environment signal. This environment signal can be received and evaluated by another road user, e.g. another vehicle, during a relative position estimation that uses an optical sensor, such as a camera system.

The optical signal is modulated with at least a part of the V2X signal, in particular with the V2X identifier of the device, i.e., in this example, the station ID of vehicle 202. The modulation may be configured as a spatial modulation. In this case, the individual LEDs may be controlled, for example, such that they have different intensities. A receiver, e.g. a computing unit, which evaluates the signal of an imaging sensor, such as a camera, is then able to derive the station ID of vehicle 202 from the spatial intensity distribution. Alternatively or in addition, the modulation may be configured as a temporal modulation, i.e., the LEDs may be controlled, for example, such that their intensity varies with time. A receiver, for example a computing unit, which evaluates the signal of a photosensor or a camera, would be able to derive the station ID of vehicle 202 from the temporal intensity distribution. Further modulation options may be employed as an alternative or in addition, e.g. a modulation of the wavelength or of the color of the radiated light.

Alternatively or in addition, signal-transmitting unit 215 may include an active radar reflector (not shown). This is configured to modulate, with the station ID of vehicle 202, an incoming radar signal that is emitted by another road user, e.g. by another vehicle, during a relative position estimation using a radar sensor, and to transmit back a radar signal that has been modulated in this way as an environment signal. This environment signal is able to be received and evaluated by other road users in order to identify the vehicle as the source of a V2X signal having the same station ID, as already described in connection with FIG. 1.

FIG. 3 shows a vehicle 301, which is configured to identify an object as the source of a V2X signal by a method according to one exemplary embodiment of the present invention. To this end, vehicle 301 includes a device 312. The device comprises a receiver 313, which is equipped for receiving V2X signals. An evaluation unit 323 is associated with the receiver, said evaluation unit being equipped to evaluate the received V2X signal, and to separate a station ID of the source of the V2X signal from the V2X signal. Device 312 further comprises an environment sensor system 311, which in this example comprises a camera system 321. In addition or alternatively, environment sensor system 311 may include a radar sensor and/or a lidar sensor (not shown). Environment sensor system 311 is equipped to receive an environment signal from the surroundings of device 312, and to perform, by way of the environment sensor system, a relative position estimation between the device and an object emitting the environment signal. In the present example, the relative position estimation may take place by evaluating the captured camera images, for example. This is conventional in the related art, and is not to be explained further at this point.

Device 312 also comprises a signal-processing unit 317, which is equipped to demodulate the environment signal captured by the camera, and thus to ascertain a V2X identifier of the object. To this end, the environment signal may be generated by a signal-transmitting unit 213 of the object, as described in connection with FIG. 2. Signal-processing unit 317 may also be equipped to recognize objects, and the positions thereof relative to vehicle 301, from the received images.

Device 312 also comprises a computing unit 318, which is equipped to compare the V2X identifier of the object ascertained from the environment signal with the V2X identifier (station ID) of the source of the V2X signal. The object is identified as the source of a received V2X signal if the V2X identifiers or station IDs have a sufficient correlation.

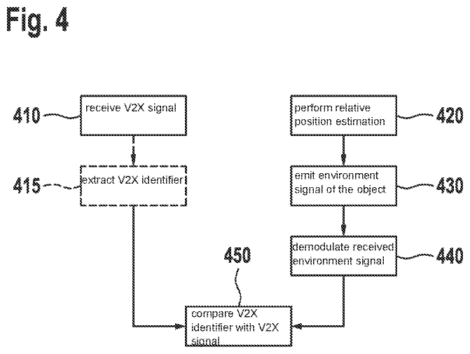

FIG. 4 shows a flow chart of an exemplary embodiment of a method according to the present invention. In step 410, a V2X signal is received from a source by a receiver of a first vehicle. In step 415, a V2X identifier, e.g. the station ID, of the source of the V2X signal may optionally then be extracted from the V2X signal. In step 420, which is performed independently of steps 410, 415, a relative position estimation is performed by way of an environment sensor system of the first vehicle, with an environment signal of an object in the surroundings of the first vehicle being received by way of the environment sensor system, and with a relative position between the first vehicle and an object emitting the environment signal, in particular a second vehicle, being determined by way of the environment sensor system. In this example, the relative position estimation is performed based on a time-of-flight measurement. To this end, the environment sensor system of the first vehicle emits a measuring signal at a first point in time. The environment signal of the object is emitted in step 430 in response to the arrival of the measuring signal. The environment sensor system of the first vehicle receives the reflected measuring signal as an environment signal at a second point in time, the distance between the first vehicle and the object being calculated based on the time difference between the first point in time and the second point in time. The environment signal emitted by the object is modulated with a V2X identifier of the object. In step 440, the received environment signal is demodulated by a signal-processing unit of the first vehicle, and a V2X identifier of the object is thus ascertained. In step 450, the V2X identifier of the object is compared with the V2X signal of the source of the V2X signal, in particular the station ID determined in step 415, the object being identified as the source of the V2X signal if the V2X identifier and the V2X signal of the source have a sufficient correlation.

15. 1-15. (canceled)

16. A method for identifying an object as a source of a V2X signal, the method comprising the following steps:
receiving a V2X signal from a source by a receiver of a first vehicle;
performing a relative position estimation, using an environment sensor system of the first vehicle, with an object from the surroundings of the first vehicle being detected by way of the environment sensor system, and with a relative position between the first vehicle and the object being determined using the environment sensor system, the environment sensor system receiving environment signals from the object, and the object modulating the environment signals at least with a part of a V2X signal of the object;
receiving the modulated environment signals by the environment sensor system of the first vehicle, and demodulating the received environment signals by a signal-processing unit of the first vehicle to ascertain a V2X identifier of the object;
comparing the V2X identifier of the object with the V2X signal of the source, the object being identified as the source of the V2X signal when the V2X identifier of the object and the V2X signal of the source have a sufficient correlation.

17. The method as recited in claim 16, wherein the object is a second vehicle.

18. The method as recited in claim 16, wherein the V2X signal of the source includes a clear V2X identifier of the source, the clear V2X identifier of the source being a V2X station ID of the source, and wherein the environment signal of the object is modulated with a clear V2X identifier of the object, the clear V2X identifier of the object being a V2X station ID of the object, and wherein, by comparing the V2X identifier of the object with the V2X identifier of the source of the V2X signal, the object is identified as the source of the V2X signal when the V2X identifiers match.

19. The method as recited in claim 16, wherein the relative position estimation is performed based on a time-of-flight measurement, the environment sensor system of the first vehicle emitting a measuring signal including an electromagnetic wave at a first point in time, and the environment signal of the object being transmitted in response to an arrival of the measuring signal, and the environment sensor system of the first vehicle receiving the environment signal at a second point in time, the distance between the first vehicle and the object being determined based on a time difference between the first point in time and the second point in time.

20. The method as recited in claim 16, wherein the environment sensor system of the first vehicle includes a radar sensor, with a radar signal being emitted as a measuring signal, using the radar sensor, into surroundings of the first vehicle, and the object including at least one active radar reflector , the active radar reflector receiving the transmitted radar signal and, in response thereto, emitting a second radar signal as the environment signal, the second radar signal being modulated with the V2X identifier of the object.

21. The method as recited in claim 16, wherein the environment sensor system of the first vehicle includes a lidar sensor, with a lidar signal being emitted as a measuring signal, using the lidar sensor, into the surroundings of the first vehicle, and the object including at least one photosensor and a lidar signal transmitter, the photosensor receiving the transmitted lidar signal, and, in response thereto, a second lidar signal being transmitted as an environment signal by the lidar signal transmitter, the second lidar signal being modulated with the V2X identifier of the object.

22. The method as recited in claim 16, wherein the environment sensor system of the first vehicle includes a camera system, and the object transmits as the environment signal an optical signal, the optical signal being modulated with the V2X identifier of the object.

23. A device for a vehicle, the device being configured to be identified as a source of a V2X signal, the device comprising:
a computing unit configured to generate the V2X signal, the V2X signal including a clear V2X identifier;
a communication unit configured to emit the V2X signal into surroundings of the device; and
a signal-transmitting unit configured to transmit an environment signal, the environment signal being modulated with the V2X identifier of the device.

24. The device as recited in claim 23, wherein the signal-transmitting unit is configured to transmit the environment signal in response to recognizing a measuring signal coming in from outside, the device including a sensor configured to detect the measuring signal.

25. The device as recited in claim 24, wherein the signal-transmitting unit includes an active radar reflector, the active radar reflector receiving a radar signal as the measuring signal, and, in response thereto, transmitting a second radar signal as the environment signal, the second radar signal being modulated with the V2X identifier of the device.

26. The device as recited in claim 24, wherein the signal-transmitting unit includes a photosensor including an IR sensor, the photosensor configured to receive a lidar signal as the measuring signal, and, in response thereto, a second lidar signal being transmitted as the environment signal by a lidar signal transmitter of the vehicle, the second lidar signal being modulated with the V2X identifier of the device.

27. The device as recited in claim 23, wherein the signal-transmitting unit includes a light source, the light source configured to continuously transmit an optical signal as the environment signal, the optical signal being modulated with the V2X identifier of the device.

28. A vehicle, comprising:
a device for a vehicle configured to be identified as a source of a V2X signal, the device including:
a computing unit configured to generate the V2X signal, the V2X signal including a clear V2X identifier,
a communication unit configured to emit the V2X signal into surroundings of the device, and
a signal-transmitting unit configured to transmit an environment signal, the environment signal being modulated with the V2X identifier of the device.

29. A device configured to identify an object as a source of a V2X signal, the device comprising:
a receiver configured to receive V2X signals;
an environment sensor system including a camera system and/or a radar sensor and/or a lidar sensor, the environment sensor system being configured to receive an environment signal from surroundings of the device, and to determine, using the environment sensor system, a relative position estimation between the device and an object transmitting the environment signal;
a signal-processing unit configured to demodulate the environment signal in order to ascertain a V2X identifier of the object;
a computing unit configured to compare the V2X identifier of the object with a V2X identifier of a source of the V2X signal, the object being identified as the source of the V2X signal when the V2X identifier of the source and of the object have a sufficient correlation.

30. A vehicle, comprising:
a device configured to identify an object as a source of a V2X signal, the device including:
a receiver configured to receive V2X signals;
an environment sensor system including a camera system and/or a radar sensor and/or a lidar sensor, the environment sensor system being configured to receive an environment signal from surroundings of the device, and to determine, using the environment sensor system, a relative position estimation between the device and an object transmitting the environment signal;
a signal-processing unit configured to demodulate the environment signal in order to ascertain a V2X identifier of the object;
a computing unit configured to compare the V2X identifier of the object with a V2X identifier of a source of the V2X signal, the object being identified as the source of the V2X signal when the V2X identifier of the source and of the object have a sufficient correlation.

31. The vehicle as recited in claim 28, wherein the vehicle is a vehicle guided in an at least partially automated fashion including a highly automated or fully automated vehicle.

32. The vehicle as recited in claim 30, wherein the vehicle is a vehicle guided in an at least partially automated fashion including a highly automated or fully automated vehicle.
